(19) United States
(12) Patent Application Publication
(10) Pub. No.: US 2026/0073127 A1
(43) Pub. Date: Mar. 12, 2026

(54) INTERACTION METHOD AND APPARATUS, ELECTRONIC DEVICE AND COMPUTER READABLE MEDIUM

(71) Applicant: Beijing Zitiao Network Technology Co., Ltd., Beijing (CN)

(72) Inventors: Mingtao LUO, Beijing (CN); Zhanhong LUO, Beijing (CN)

(21) Appl. No.: 19/106,202

(22) PCT Filed: Nov. 22, 2023
(86) PCT No.: PCT/CN2023/133478

§ 371 Date: Feb. 24, 2025

(30) Foreign Application Priority Data
Nov. 24, 2022 (CN) 202211484415.1

(51) Int. Cl. G06F 40/18; G06F 3/0483

(52) U.S. Cl. CPC G06F 40/18; G06F 3/0483

(57) ABSTRACT

The present disclosure discloses an interaction method and apparatus, an electronic device, and a computer-readable medium. The method includes: when a table content editing page corresponding to a target table is being displayed, after a formula editing operation triggered for the table content editing page is received, determining overall complexity representation data of a target formula corresponding to the formula editing operation, and displaying the overall complexity representation data on the table content editing page, such that a user can view the overall complexity representation data of the target formula in as much real time as possible after editing the target formula.

### CROSS-REFERENCE TO RELATED APPLICATION(S)

This application is a national stage application filed under 35 U.S. C. 371 based on International Patent Application No. PCT/CN2023/133478, filed Nov. 22, 2023, which claims the benefit of the Chinese Patent Application No. 202211484415.1 filed on Nov. 24, 2022, the disclosures of which are incorporated herein by reference in their entireties.

### FIELD

The present disclosure relates to the field of Internet technologies, in particular to an interaction method and apparatus, an electronic device, and a computer-readable medium.

### BACKGROUND

With the widespread use of computers, the applications for spreadsheets are becoming increasingly diverse. In this context, users can perform various interaction operations on a spreadsheet (for example, inputting data or inputting formulas into the spreadsheet) to meet their interaction needs (such as data entry needs and formula input needs).

### SUMMARY

In order to solve the technical problems described above, the present disclosure provides an interaction method and apparatus, an electronic device, and a computer-readable medium.

To achieve the above object, the present disclosure provides the following technical solutions.

The present disclosure provides an interaction method, the method including:
displaying a table content editing page corresponding to a target table;
in response to a formula editing operation triggered for the table content editing page, determining overall complexity representation data for a target formula corresponding to the formula editing operation, and displaying the overall complexity representation data for the target formula on the table content editing page, wherein the overall complexity representation data is determined from complexity representation data of the minimum computation unit in the target formula.

In one possible implementation, a determination process of the overall complexity representation data of the target formula includes:
subjecting the target formula to a minimum computation unit parsing process to obtain at least one computation unit to be used;
determining self-complexity representation data of the target formula according to complexity representation data of the at least one computation unit to be used; and
determining the overall complexity representation data of the target formula according to the self-complexity representation data of the target formula.

In one possible implementation, the determining the overall complexity representation data of the target formula according to the self-complexity representation data of the target formula includes:
if there is a preset dependency between the target formula and at least one formula to be referenced in the target table, subjecting the self-complexity representation data of the target formula and self-complexity representation data of the at least one formula to be referenced to a summation process, to obtain the overall complexity representation data of the target formula; and
if there is no preset dependency between the target formula and each formula in the target table, determining the self-complexity representation data of the target formula as the overall complexity representation data of the target formula.

In one possible implementation, the determining self-complexity representation data of the target formula according to complexity representation data of the at least one computation unit to be used includes:
determining self-complexity representation data of the target formula according to the complexity representation data of the at least one computation unit to be used and a unit type of the at least one computation unit to be used.

In one possible implementation, the determining self-complexity representation data of the target formula according to the complexity representation data of the at least one computation unit to be used and a unit type of the at least one computation unit to be used includes:
filtering out at least one function computation unit from the at least one computation unit to be used according to the unit type of the at least one computation unit to be used, the function computation unit being of a preset unit type; and
determining the sum of the complexity representation data of all the function computation units as the self-complexity representation data of the target formula.

In one possible implementation, a determination process of the complexity representation data of the function computation unit includes:
obtaining size representation data of input parameters of the function computation unit;
determining a complexity prediction unit corresponding to the function computation unit according to a unit identifier of the function computation unit; and
inputting the size representation data into the complexity prediction unit to obtain the complexity representation data of the function computation unit output by the complexity prediction unit.

In one possible implementation, the complexity prediction unit is derived from a fitting process according to a fitting reference data set corresponding to the function computation unit and a curve to be fitted corresponding to the function computation unit; and the fitting reference data set includes at least one first input parameter size representation data corresponding to the function computation unit and actual complexity representation data corresponding to the at least one first input parameter size representation data; or
the complexity prediction unit is derived from a training process according to a training data set corresponding to the function computation unit and a model to be trained corresponding to the function computation unit; and the training data set includes at least one second input parameter size representation data corresponding to the function computation unit and actual complexity representation data corresponding to the at least one second input parameter size representation data.

In one possible implementation, if an upstream computation unit corresponding to the function computation unit exists in the target formula, the size representation data of the input parameters of the function computation unit is determined from the size representation data of the output result of the upstream computation unit.

In one possible implementation, the size representation data of the output result of the upstream computation unit is determined according to the unit type of the upstream computation unit.

In a possible implementation, the method further includes:
in response to a formula editing operation triggered for the table content editing page, displaying adjustment suggestion prompt information corresponding to the target formula; and
in response to a trigger operation for the adjustment suggestion prompt information, displaying a formula adjustment guide interface corresponding to the target formula.

The present disclosure further provides an interaction apparatus, including:
a first display module configured to display a table content editing page corresponding to a target table;
a second display module configured to, in response to a formula editing operation triggered for the table content editing page, determine overall complexity representation data for a target formula corresponding to the formula editing operation, and display the overall complexity representation data for the target formula on the table content editing page, where the overall complexity representation data is determined from complexity representation data of the minimum computation unit in the target formula.

The present disclosure further provides an electronic device. The electronic device includes: a processor and a memory,
the memory is configured to store instructions or a computer program; and
the processor is configured to execute the instructions or computer program in the memory to cause the electronic device to perform the interaction method provided by the present disclosure.

The present disclosure also provides a computer-readable medium having instructions or a computer program stored therein which, when run on a device, cause the device to perform the interaction method provided by the present disclosure.

The present disclosure provides a computer program product, which includes a computer program carried on a non-transitory computer-readable medium, where the computer program includes program code for performing the interaction method provided by the present disclosure.

### BRIEF DESCRIPTION OF THE DRAWINGS

In order to more clearly describe the technical solutions in the embodiments of the present disclosure or in the prior art, the accompanying drawings for describing the embodiments or the prior art will be briefly described below. Apparently, the accompanying drawings in the description below show merely some embodiments recited in the present disclosure, and those of ordinary skill in the art may still derive other accompanying drawings from these accompanying drawings without creative efforts.

FIG. 1 is a flowchart of an interaction method according to an embodiment of the present disclosure;

FIG. 2 is a schematic diagram of a formula parsing tree according to an embodiment of the present disclosure;

FIG. 3 is a schematic diagram of dependency relationship between formulas according to an embodiment of the present disclosure;

FIG. 4 is a schematic diagram of a structure of an interaction apparatus according to an embodiment of the present disclosure; and

FIG. 5 is a schematic diagram of a structure of an electronic device according to an embodiment of the present disclosure.

### DETAILED DESCRIPTION OF EMBODIMENTS

In order for persons skilled in the art to better understand the solutions of the present disclosure, the technical solutions in the embodiments of the present disclosure will be described below clearly and completely with reference to the accompanying drawings in the embodiments of the present disclosure. Apparently, the embodiments described are merely some rather than all of the embodiments of the present disclosure. All other embodiments obtained by those of ordinary skill in the art based on the embodiments of the present disclosure without any creative efforts shall fall within the scope of protection of the present disclosure.

Due to certain flaws in the interaction processes related to spreadsheets, the user experience may be suboptimal.

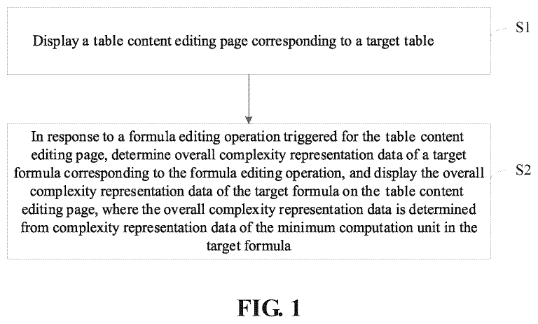

For a better understanding of the technical solution provided by the present disclosure, the interaction method provided by the present disclosure is described below in conjunction with some drawings. As shown in FIG. 1, an interaction method according to an embodiment of the present disclosure includes the following steps S1 and S2. FIG. 1 is a flowchart of an interaction method according to an embodiment of the present disclosure.

S1: Display a table content editing page corresponding to a target table.

The target table refers to a spreadsheet that requires formula complexity determination; and the target table is not limited in the present disclosure.

The table content editing page is a page used to provide a user with relevant editing functions (e.g., editing functions, such as inputting data, and inputting formulas) for the target table; and the implementation of the table content editing page is not limited in the present disclosure; for example, the table content editing page may be implemented in the form of any existing or future page capable of editing formulas.

S2: In response to a formula editing operation triggered for the table content editing page, determine overall complexity representation data of a target formula corresponding to a formula editing operation, and display the overall complexity representation data of the target formula on the table content editing page, wherein the overall complexity representation data is determined based on complexity representation data of a minimum computation unit in the target formula.

The formula editing operation is used to input a formula into the above-mentioned target table; and the formula editing operation is not limited in the present disclosure; for example, the formula editing operation may be implemented in the form of any existing or future operation capable of inputting a formula into a spreadsheet.

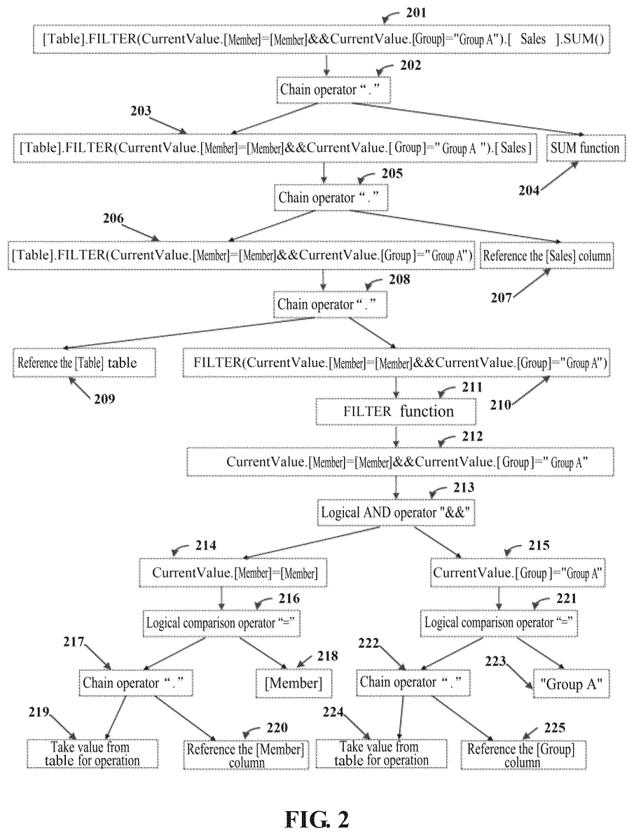

The target formula refers to a formula input into a spreadsheet by the user through performing the above-mentioned formula editing operation. For example, the target formula may be a formula shown in FIG. 2 in an area 201. It should be noted that the main meaning of the formula shown in the area 201 is: subjecting sales figures of all members belonging to a group A in the spreadsheet named “Table” to summation processing.

The above-mentioned “overall complexity representation data of the target formula” is used to describe a complexity condition (e.g., temporal complexity, etc.) presented by the execution of the target formula; and the overall complexity representation data is not limited in the present disclosure; for example, the overall complexity representation data may include at least temporal complexity.

In practice, for a formula, the formula (e.g., the formula shown in FIG. 2 in the area 201) is typically made up of some computation units (e.g., minimum computation units shown in areas 202 to 225 in FIG. 2), so that the complexity of the formula is affected by the complexity of the computation units themselves. Based on this, the present application also provides a determination process of the above-mentioned “overall complexity representation data of the target formula”, which may specifically be: determining the overall complexity representation data of the target formula based on the complexity representation data of the minimum computation unit in the target formula. For ease of understanding, the following explanation will include an example.

As an example, the determination process of the above-mentioned “overall complexity representation data of the target formula” may specifically include steps 11 to 13 below.

Step 11: Subject the target formula to minimum computation unit parsing, to obtain at least one computation unit to be used.

The minimum computation unit refers to a computation unit (e.g., the computation unit shown in the area 202 in FIG. 2, etc.) that can be invoked during execution of the formula in the above target table, and that cannot be further parsed or broken down, and each formula is made up of one or more minimum computation units.

The minimum computation unit parsing is used to parse constituent units of a formula; and the implementation of the minimum computation unit parsing is not limited in the present disclosure.

The above-mentioned “at least one computation unit to be used” is used to describe the minimum computation units involved in the above target formula. For example, if the target formula is the formula shown in the area 201 in FIG. 2, the “at least one computation unit to be used” may include the computation units shown in the area 202, the area 204, the area 205, the area 207, the area 208, the area 209, the area 211, the area 213, the area 216, the area 217, the area 218, the area 220, the area 221, the area 222, the area 223 and the area 225, etc., in FIG. 2.

Additionally, the above-mentioned “at least one computation unit to be used” is not limited in the present disclosure, for example, the at least one computation unit may include at least one function computation unit (e.g., the computation units shown in the area 202, the area 204, the area 205, the area 208, the area 211, the area 213, the area 216, the area 217, the area 221 and the area 222 in FIG. 2), at least one data reference unit (e.g., the computation units shown in the area 207, the area 209, the area 218, the area 220, and the area 225 in FIG. 2), and at least one constant usage unit (e.g., the computation unit shown in the area 223 in FIG. 2). Each function computation unit belongs to a function type node, which typically involves logical operations; each data reference unit belongs to a reference type node, which is typically used to invoke certain data from a certain data source; and each constant usage unit belongs to a constant type node, which generally refers to the use of a specific data value (e.g., a string, a number, etc.).

In addition, the representation manner of the above-mentioned “at least one computation unit to be used” is not limited in the present disclosure, which may be represented, for example, in a tree structure similar to a tree structure shown in FIG. 2.

Step 12: Determine self-complexity representation data of the target formula based on complexity representation data of the above at least one computation unit to be used.

In an embodiment of the present disclosure, after parsing the at least one computation unit to be used from the target formula, the complexity representation data of all computation units to be used may be subjected to summation processing, to obtain the self-complexity representation data of the target formula, so that the self-complexity representation data represents a complexity condition of the target formula itself.

In practice, different types of computation units have different degrees of impact on the complexity of the target formula. For example, due to the minimal time consumption involved in obtaining constant type nodes, these nodes have almost no impact on the complexity of the target formula. Therefore, to better improve the efficiency of complexity determination, the complexity brought by constant type nodes can be ignored in the process of determining the self-complexity representation data of the target formula. Similarly, due to the minimal time consumption involved in obtaining reference type nodes, these nodes have almost no impact on the complexity of the target formula. Therefore, to better improve the efficiency of complexity determination, the complexity brought by reference type nodes can be ignored in the process of determining the self-complexity representation data of the target formula. However, due to the significant resources (e.g., temporal resources) required in the process of obtaining function type nodes, these nodes can have a relatively large impact on the complexity of the target formula. Therefore, the complexity brought by function type nodes needs to be considered in the process of determining the self-complexity representation data of the target formula.

Based on the above, in some application scenarios, in order to better improve the efficiency of the formula complexity determination, the present disclosure further provides one possible implementation of the above step 12, which may specifically be: determining self-complexity representation data of the target formula according to the complexity representation data of the at least one computation unit to be used and a unit type of the at least one computation unit to be used. Herein, a unit type is used to describe the type to which a computation unit belongs (e.g., the unit type of the function computation unit above is a function type node, the unit type of the data reference unit above is a reference type node, and the unit type of the constant usage unit above is the constant type node). For a better understanding, the following is described in conjunction with examples.

By way of example, in a possible implementation, step 12 above may specifically include steps 121 to 122 below.

Step 121: Select at least one function computation unit from the above-mentioned at least one computation unit to be used based on the unit type of the at least one computation unit to be used, and the function computation unit is of a preset unit type.

The preset unit type may be set in advance according to the application scenario, for example, in a possible implementation, the preset unit type may be in particular the above-mentioned function type node.

The above-mentioned “function computation unit” refers to the minimum computation unit belonging to the function type node that exists in the above target formula.

Step 122: Determine a sum of the complexity representation data of all the function computation units as the self-complexity representation data of the target formula.

The complexity representation data of the i-th function computation unit is used to represent a complexity condition (e.g., temporal complexity) presented by the i-th function computation unit. i is a positive integer, i≤I, I is a positive integer, and I represents the number of computation units among the above-mentioned “at least one function computation unit”.

In addition, the determination process of the above-mentioned “complexity representation data of the i-th function computation unit” is not limited in the present disclosure, for example, the determination process may be implemented using any existing or future method capable of obtaining the complexity of a computation unit. For another example, the determination process may be implemented using manual annotation.

In practice, for a function computation unit, the complexity of the function computation unit depends not only on the implementation complexity of the function involved in the function computation unit, but also on the data size of the input parameters of the function computation unit (e.g. the larger the data size of the input parameters, the greater the temporal complexity of the function computation unit). Based on this, the present disclosure further provides a determination process of the above-mentioned “complexity representation data of the i-th function computation unit”, which may specifically include steps 21 to 23 below.

Step 21: Obtain size representation data of input parameters of the i-th function computation unit.

The above-mentioned “size representation data of input parameters of the i-th function computation unit” is used to represent the data size (e.g., data volume size) reached by the input parameters of the i-th function computation unit; and the above-mentioned “size representation data of the input parameters of the i-th function computation unit” is not limited in the present disclosure, for example, the size representation data of the input parameters of the i-th function computation unit may be the amount of data carried by the input parameters of the i-th function computation unit.

In addition, the determination manner of the above-mentioned “size representation data of the input parameters of the i-th function computation unit” is not limited in the present disclosure.

In practice, for two computation units having data transmission adjacencies in a formula, since the input parameters of a downstream computation unit (e.g., the computation unit shown in the area 213 in FIG. 2) are typically determined based on an output result of an upstream computation unit (e.g., the computation unit shown in the area 214 and the area 215 in FIG. 2), so that the size representation data of the input parameters of the downstream computation unit can be determined based on the size representation data of the output result of the upstream computation unit. Based on this, the present disclosure further provides a determination process of the above-mentioned “size representation data of the input parameters of the i-th function computation unit”, which may specifically be that: when the upstream computation unit corresponding to the i-th function computation unit is present in the above-mentioned target formula, the size representation data of the input parameters of the i-th function computation unit may be determined based on the size representation data of the output result of the upstream computation unit. Herein, the upstream computation unit is used to provide input parameters to the i-th function computation unit, and the present application does not limit the upstream computation unit. For example, the upstream computation unit may be a minimum computation unit or a composite computation unit composed of a plurality of minimum computation units.

The above-mentioned “size representation data of the output result of the upstream computation unit” is used to represent the data size reached by the output result of the upstream computation unit; and the present disclosure does not limit the determination process of the “size representation data of the output result of the upstream computation unit”, for example, which may specifically be: determining the size representation data of the output result of the upstream computation unit according to the unit type of the upstream computation unit.

In addition, the present disclosure does not limit the above step “determining the size representation data of the output result of the upstream computation unit according to the unit type of the upstream computation unit”, for example, which may specifically be as follows: when the unit type of the upstream computation unit is a constant type node, if the output result of the upstream computation unit is of a basic data type (e.g., a character, a number, etc.), the size representation data of the output result of the upstream computation unit can be determined as 1, and if the output result of the upstream computation unit is of a set type (e.g., a vector, a matrix, etc.), the size representation data of the output result of the upstream computation unit is determined as the data volume size of the set; when the unit type of the upstream computation unit is a reference type node, the size representation data of the output result of the upstream computation unit can be determined as the data volume size of the referenced data source; and when the unit type of the upstream computation unit is a function type node, the size representation data of the output result of the upstream computation unit can be determined as the data volume size of the output result.

Furthermore, the present disclosure also does not limit the implementation of the above step “determining the size representation data of the input parameters of the i-th function computation unit according to the size representation data of the output result of the upstream computation unit”, for example, when there are N upstream computation units corresponding to the i-th function computation unit in the above target formula, it may specifically be as follows: the size representation data of the output result of the 1st upstream computation unit to the size representation data of the output result of the N-th upstream computation unit are aggregated, to obtain size representation data of input parameters of the i-th function computation unit, such that the “size representation data of the input parameters of the i-th function computation unit” includes size representation data of the output results of the N upstream computation units. Herein, N is a positive integer.

Step 22: Determine a complexity prediction unit corresponding to the i-th function computation unit according to a unit identifier of the i-th function computation unit.

Herein, the unit identifier of the i-th function computation unit is used to uniquely represent the i-th function computation unit, and the present disclosure does not limit the implementation of the “unit identifier of the i-th function computation unit”.

The above-mentioned “complexity prediction unit corresponding to the i-th function computation unit” refers to a pre-constructed computation unit suitable for performing complexity prediction processing for the i-th function computation unit; and the present disclosure does not limit the implementation of the “complexity prediction unit corresponding to the i-th function computation unit”; for example, it may be implemented with a pre-fitted curve function. For example, it can also be implemented with a pre-trained machine learning model. For ease of understanding, the following explanation will include two examples.

Example 1, if the above-mentioned “complexity prediction unit corresponding to the i-th function computation unit” is a pre-fitted curve function, the determination process of the “complexity prediction unit corresponding to the i-th function computation unit” may specifically be: performing fitting based on to a fitting reference data set corresponding to the i-th function computation unit, and a curve to be fitted corresponding to the i-th function computation unit, to obtain the complexity prediction unit corresponding to the i-th function computation unit.

The above-mentioned “fitting reference data set corresponding to the i-th function computation unit” refers to a data set required for fitting a complexity prediction curve function corresponding to the i-th function computation unit, and the “fitting reference data set corresponding to the i-th function computation unit” is not limited in the present disclosure; for example, the fitting reference data set corresponding to the i-th function computation unit may include at least one first input parameter size representation data corresponding to the i-th function computation unit, and actual complexity representation data corresponding to the at least one first input parameter size representation data. The first input parameter size representation data is used to describe the data size reached by the input parameters of the i-th function computation unit during a computation process, while the actual complexity representation data corresponding to the first input parameter size representation data is used to represent the complexity condition actually presented by the i-th function computation unit with the first input parameter size representation data. It should be noted that the present disclosure does not limit the method in which the “actual complexity representation data corresponding to the first input parameter size representation data” is obtained; for example, it may be implemented using methods such as manual annotation.

The above-mentioned “curve to be fitted corresponding to the i-th function computation unit” refers to the curve function that needs to be fitted when fitting the complexity prediction curve function corresponding to the i-th function computation unit, and there are some parameters that need to be determined by the fitting process in the “curve to be fitted corresponding to the i-th function computation unit”. In addition, the “curve to be fitted corresponding to the i-th function computation unit” can be set in advance according to the i-th function computation unit.

It should be noted that the present disclosure does not limit the implementation of the above-mentioned “fitting process”; for example, it may be implemented using either existing or future fitting methods of any curve function.

Based on the relevant content of Example 1 above, it can be seen that in some cases, a complexity prediction unit corresponding to a function computation unit can be determined using curve fitting, so that this complexity prediction unit can represent the correlation between the input parameter size of the function computation unit and the complexity condition of the function computation unit (for example, the trend of how the complexity condition of the function computation unit changes with variations in its input parameter size), allowing for the subsequent determination of the complexity condition of the function computation unit under different input parameter sizes based on the complexity prediction unit.

Example 2, if the above-mentioned “complexity prediction unit corresponding to the i-th function computation unit” is a pre-trained machine learning model, the determination process of the “complexity prediction unit corresponding to the i-th function computation unit” may specifically be as follows: performing training process based on the training data set corresponding to the i-th function computation unit and the model to be trained corresponding to the i-th function computation unit, to obtain the complexity prediction unit corresponding to the i-th function computation unit.

The above-mentioned “training data set corresponding to the i-th function computation unit” refers to the data set required for training the complexity prediction model corresponding to the i-th function computation unit, and the present disclosure does not limit the “training data set corresponding to the i-th function computation unit”; for example, it can include at least one second input parameter size representation data corresponding to the i-th function computation unit and the actual complexity representation data corresponding to the at least one second input parameter size representation data. Herein, the second input parameter size representation data is used to describe the data size reached by the input parameters of the i-th function computation unit during a certain computation process, while the actual complexity representation data corresponding to the second input parameter size representation data is used to represent the complexity condition actually presented by the i-th function computation unit with the second input parameter size representation data. It should be noted that the present disclosure does not limit the method in which the “actual complexity representation data corresponding to the second input parameter size representation data” is obtained; for example, it may be implemented using methods such as manual annotation.

The “model to be trained corresponding to the i-th function computation unit” refers to the machine learning model that needs to be trained when training the complexity prediction model corresponding to that i-th function computation unit, and the “model to be trained corresponding to the i-th function computation unit” contains some network parameters that need to be determined by the training process. In addition, the “model to be trained corresponding to the i-th function computation unit” can be set in advance according to the i-th function computation unit.

It should be noted that the present disclosure does not limit the implementation of the above-mentioned “training process”; for example, it may be implemented using any of the existing or future model training methods.

Based on the relevant content of Example 2 above, it can be seen that in some cases, a complexity prediction unit corresponding to a function computation unit can be determined by machine model training, so that this complexity prediction unit can represent the correlation between the input parameter size of the function computation unit and the complexity condition of the function computation unit, allowing for the subsequent determination of the complexity condition of the function computation unit under different input parameter sizes based on the complexity prediction unit.

In practice, in some application scenarios, after obtaining the complexity prediction units corresponding to respective function computation units, the correspondences between the unit identifiers of the respective function computation units and the complexity prediction units corresponding to respective function computation units may first be established. Then, these correspondences may be used to construct a mapping relationship, so that the mapping relationship represents the correspondences between the unit identifiers of the respective function computation units and the corresponding complexity prediction units of the respective function computation units, allowing for the subsequent retrieval of the complexity prediction unit corresponding to each function computation unit with the mapping relationship.

It can be learned that, in a possible implementation, the above step 22 may be specifically as follows: after obtaining the unit identifier of the i-th function computation unit, looking up the complexity prediction unit corresponding to the unit identifier of the i-th function computation unit from the pre-constructed mapping relationship, and determining same as the complexity prediction unit corresponding to the i-th function computation unit.

Based on the relevant content of the above Step 22, after determining that there is an i-th function computation unit in the target formula, the complexity prediction unit corresponding to the i-th function computation unit can be identified using the unit identifier of the i-th function computation unit. This complexity prediction unit can then determine the complexity representation data of the i-th function computation unit based on the size representation data of the input parameters of the i-th function computation unit, allowing for the subsequent prediction of the complexity condition of the target formula based on the complexity representation data of the i-th function computation unit.

Step 23: Input the size representation data of the input parameters of the i-th function computation unit into the complexity prediction unit corresponding to the i-th function computation unit to obtain the complexity representation data of the i-th function computation unit output by the complexity prediction unit.

Based on the relevant content of steps 21 to 23 above, for any function computation unit, the complexity representation data of the i-th function computation unit can be predicted using the size representation data of its input parameters and the complexity prediction unit corresponding to the function computation unit, so that this complexity representation data can represent the complexity condition presented by the function computation unit under the size representation data.

Based on the relevant content of steps 121 to 122 above, for the target formula, after parsing the at least one computation unit to be used from the target formula, the function computation units that belong to function type nodes are first filtered from these computation units to be used. Then, the sum of the complexity representation data of all function computation units is determined as the self-complexity representation data of the target formula, so that the self-complexity representation data can represent the complexity of the target formula itself. This approach allows for improving the efficiency of complexity determination while ensuring the effectiveness of the complexity determination.

Step 13: Determine the overall complexity representation data of the target formula according to the self-complexity representation data of the target formula.

It should be noted that the present disclosure does not limit the implementation of step 13, for example, in some application scenarios (e.g., in a scenario where there is no reference relationship between different formulas in the spreadsheet), step 13 may specifically be: determining the self-complexity representation data of the target formula as the overall complexity representation data of the target formula.

In practice, in other application scenarios (for example, in cases where different formulas in a spreadsheet may have reference relationships), for a formula, if that formula does not reference the output results of other formulas in the spreadsheet, its actual complexity is simply its own complexity. However, if that formula needs to reference the output results of other formulas in the spreadsheet, its actual complexity will be influenced not only by its own complexity but also by the complexities of the other formulas. Based on this, the present disclosure also provides a possible implementation of step 13 above, which may specifically include steps 131 to 132 below.

Step 131: Subject the self-complexity representation data of the target formula and self-complexity representation data of at least one formula to be referenced to summation processing, to obtain the overall complexity representation data of the target formula if there is a preset dependency relationship between the target formula and the at least one formula to be referenced in the target table.

The j-th formula to be referenced refers to a formula that exists in the above-mentioned target table and has a preset dependency relationship with the above-mentioned target formula. j is a positive integer, where j≤J, and J is a positive integer, and J represents the number of formulas among the above-mentioned “at least one formula to be referenced”.

The above-mentioned “preset dependency relationship” may be preset, for example, which may specifically be as follows: the above-mentioned target formula either directly references an output result of the j-th formula to be referenced or indirectly references the output result of the j-th formula to be referenced. For ease of understanding, the following explanation will include an example.

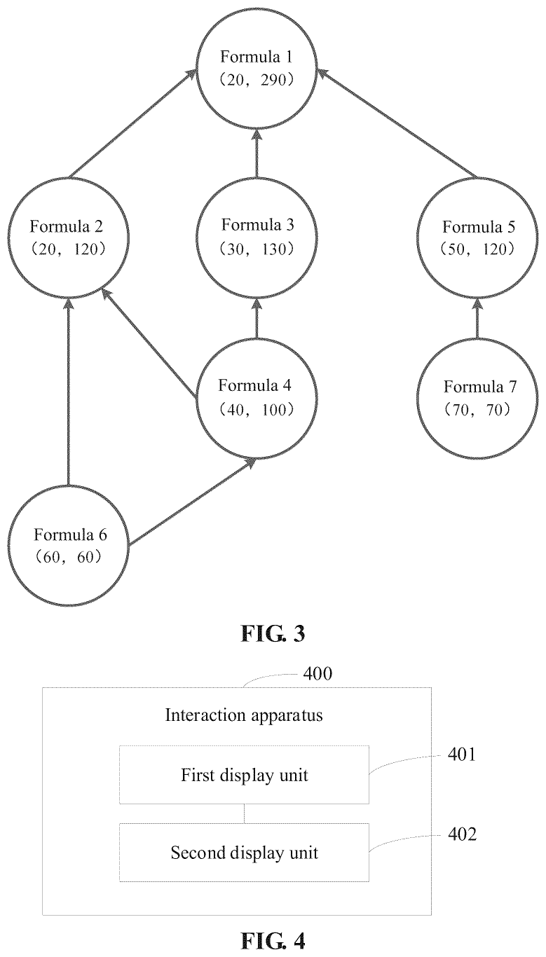

As an example, when the above-mentioned target table includes formulas 1 to 7 in FIG. 3, if the target formula is formula 1 in FIG. 3, since formula 1 requires the output results of formulas 2, 3, and 5 to operate, it can be determined that. Therefore, it can be established that formula 1 will directly reference the output results of Formulas 2, 3, and 5, creating direct dependencies between Formula 1 and Formulas 2, 3, and 5. Additionally, formula 2 needs to operate based on output results of formulas 4 and 6, such that when formula 1 is executed, output results of formulas 4 and 6 are indirectly invoked due to the invoking of the output result of formula 2, formula 1 indirectly references the output results of formulas 4 and 6, thereby establishing indirect dependency relationships between formula 1 and formula 4 or formula 6.

It can be learned from FIG. 3 that if the above-mentioned target table includes formulas 1 to 7 in FIG. 3, since formula 1 needs to directly reference the output results of formulas 2, 3, and 5, formula 2 needs to directly reference formulas 4 and 6, formula 3 needs to directly reference formula 4, formula 4 needs to directly reference formula 6, and formula 5 needs to directly reference formula 7, when the above-mentioned target formula is formula 1 in FIG. 3, the target formula directly references the output results of formulas 2, 3, and 5, and indirectly references the output results of formulas 4, 6, and 7. As a result, formulas 2 to 7 will satisfy the preset dependency with the target formula, making at least one formula to be referenced corresponding to the target formula include formulas 2 to 7.

The self-complexity representation data of the j-th formula to be referenced is used to describe the complexity condition of that j-th formula to be referenced. Moreover, the determination process for the “self-complexity representation data of the j-th formula to be referenced” is similar to the determination process for the “self-complexity representation data of the target formula” mentioned above. For the sake of brevity, it will not be elaborated on here.

Based on the relevant content of step 131 above, for the target formula in the aforementioned target table, if there is a preset dependency between this target formula and the J formulas to be referenced in the target table, the self-complexity representation data of the target formula (for example, 20 corresponding to Formula 1 in FIG. 3), the self-complexity representation data of the 1st formula to be referenced (for example, 20 corresponding to Formula 2 in FIG. 3), the self-complexity representation data of the 2nd formula to be referenced (for example, 30 corresponding to Formula 3 in FIG. 3), . . . , and the self-complexity representation data of the J-th formula to be referenced (for example, 70 corresponding to Formula 7 in FIG. 3) can be summed to obtain the overall complexity representation data of the target formula (for example, 290 corresponding to Formula 1 in FIG. 3). This overall complexity representation data can describe the complexity condition presented when the target formula is actually executed (for example, time consumption, etc.).

It should be noted that, for FIG. 3, in the binary group (20, 290) corresponding to Formula 1 in FIG. 3, the value “20” refers to the self-complexity representation data of Formula 1, and the value “290” refers to the overall complexity representation data of Formula 1; in the binary group (20, 120) corresponding to Formula 2 in FIG. 3, the value “20” refers to the self-complexity representation data of Formula 2, and the value “120” refers to the overall complexity representation data of Formula 2; in the binary group (30, 130) corresponding to Formula 3 in FIG. 3, the value “30” refers to the self-complexity representation data of Formula 3, and the value “130” refers to the overall complexity representation data of Formula 3; in the binary group (40, 100) corresponding to Formula 4 in FIG. 3, the value “40” refers to the self-complexity representation data of Formula 4, and the value “100” refers to the overall complexity representation data of Formula 4; . . . (and so on).

Step 132: If there is no preset dependency between the target formula and each formula in the target table, determine the self-complexity representation data of the target formula as the overall complexity representation data of the target formula.

In the present disclosure, for the target formula in the above target table, if there is no preset dependency between the target formula and each formula in the target table, it can be determined that the target formula does not reference the output result of any one of the formulas in the target table. Thus, it can be determined that the actual complexity of the target formula is only affected by its own complexity, so the self-complexity representation data of the target formula can be determined as the overall complexity representation data of the target formula.

Based on the relevant content of steps 131 and 132 above, for a formula, if that formula directly or indirectly references the output results of other formulas in the spreadsheet, the overall complexity representation data of the formula can be determined based on its own complexity and the complexities of all the referenced formulas.

As can be seen from the above related contents of S1 to S2, for the interaction method provided in the embodiment of the present disclosure, when the electronic device is displaying a table content editing page corresponding to a target table (a certain spreadsheet), after a formula editing operation triggered for the table content editing page is received by the electronic device, overall complexity representation data of a target formula corresponding to the formula editing operation is determined, and the overall complexity representation data of the target formula is displayed on the table content editing page, such that a user can view the overall complexity representation data of the target formula in as much real time as possible after editing the target formula. Thus, the understanding requirement of the user for the complexity of the target formula can be met, thereby facilitating improvement of the user experience.

In addition, since the overall complexity representation data of the above target formula is theoretically derived based on the complexity representation data of the minimum computation unit to which the target formula relates, it is not necessary to complete the execution process for the target formula when obtaining the overall complexity representation data of the target formula. This makes it possible to effectively avoid the adverse effects caused by the execution of the target formula (e.g., it takes a lot of time, etc.), thereby improving the efficiency of the determination of the overall complexity representation data of the target formula, which in turn improves the real-time display of the overall complexity representation data, thus better improving the user experience.

In addition, embodiments of the present disclosure do not limit the execution subject of the interaction method, for example, the interaction method provided in the embodiments of the present disclosure may be applied to a data processing device such as a terminal device or a server. For another example, the interaction method provided by embodiments of the present disclosure may also be implemented by means of a data communication process between terminal devices or servers. Herein, the terminal device may be a smartphone, a computer, a personal digital assistant (PDA) or a tablet. The server may be a stand-alone server, a cluster server, or a cloud server.

In practice, in order to better enhance the user experience, the present disclosure also provides one possible implementation of the above interaction method, in which the interaction method may include steps 31-33 below.

Step 31: Display a table content editing page corresponding to a target table.

It should be noted that for details related to Step 31, please refer to the relevant content of S1 mentioned above.

Step 32: In response to a formula editing operation triggered for the table content editing page, determine overall complexity representation data for a target formula corresponding to the formula editing operation, and display the overall complexity representation data for the target formula on the table content editing page, and display adjustment suggestion prompt information corresponding to the target formula.

For details related to the above step “in response to a formula editing operation triggered for the table content editing page, determine overall complexity representation data for a target formula corresponding to the formula editing operation, and display the overall complexity representation data for the target formula on the table content editing page”, please refer to the relevant content of S2 mentioned above.

The “adjustment suggestion prompt information corresponding to the target formula” is used to inform the user how to adjust the target formula to reduce its complexity.

Additionally, embodiments of the present disclosure do not limit the determination process of the “adjustment suggestion prompt information corresponding to the target formula”; for example, it can be implemented using a pre-constructed computation unit with adjustment suggestion generation functionality (such as a machine learning model, a mapping relationship constructed based on a large number of formulas and their corresponding adjustment suggestions, or a retrieval library built on pre-set formula adjustment suggestion generation rules, etc.).

Step 33: In response to a trigger operation for the adjustment suggestion prompt information, display a formula adjustment guide interface corresponding to the target formula.

Herein, the formula adjustment guide interface is used to guide the user to perform complexity optimization for the above target formula; and the present disclosure does not limit the formula adjustment guide interface, for example, the formula adjustment guide interface may have at least the following functions: a formula editing function and an adjustment suggestion display function.

In addition, the present application does not limit the implementation of the above-mentioned “trigger operation for the adjustment suggestion prompt information”; for example, it may be a click operation.

Based on the relevant content of steps 31 to 33 above, for a client with spreadsheet processing capabilities, after the client receives a formula input for the spreadsheet, it will not only immediately display the overall complexity representation data of the formula but also present the adjustment suggestion prompt information corresponding to the formula. This allows the user to optimize the complexity condition of the formula based on the adjustment suggestion prompt information, thereby enhancing the user's formula editing experience.

Based on the interaction method according to the embodiments of the present disclosure, an embodiment of the present disclosure further provides an interaction apparatus, which is explained and described below with reference to FIG. 4. Herein, FIG. 4 is a schematic diagram of a structure of an interaction apparatus according to an embodiment of the present disclosure. It should be noted that for the technical details of the interaction apparatus provided by the embodiment of the present disclosure, reference may be made to the relevant content of the interactive method described above.

As shown in FIG. 4, an interaction apparatus 400 provided in an embodiment of the present disclosure includes:
a first display module 401 configured to display a table content editing page corresponding to a target table;
a second display module 402 configured to, in response to a formula editing operation triggered for the table content editing page, determine overall complexity representation data for a target formula corresponding to the formula editing operation, and display the overall complexity representation data for the target formula on the table content editing page, where the overall complexity representation data is determined from complexity representation data of the minimum computation unit in the target formula.

In one possible implementation, the second display module 402 includes:
a formula parsing sub-module configured to subject the target formula to a minimum computation unit parsing process to obtain at least one computation unit to be used;
a first determination sub-module configured to determine self-complexity representation data of the target formula according to complexity representation data of the at least one computation unit to be used; and
a second determination sub-module configured to determine the overall complexity representation data of the target formula according to the self-complexity representation data of the target formula.

In one possible implementation, the second determination sub-module is specifically configured to:
if there is a preset dependency between the target formula and at least one formula to be referenced in the target table, subject the self-complexity representation data of the target formula and self-complexity representation data of the at least one formula to be referenced to a summation process, to obtain the overall complexity representation data of the target formula; and
if there is no preset dependency between the target formula and each formula in the target table, determine the self-complexity representation data of the target formula as the overall complexity representation data of the target formula.

In one possible implementation, the first determination sub-module is specifically configured to: determine self-complexity representation data of the target formula according to the complexity representation data of the at least one computation unit to be used and a unit type of the at least one computation unit to be used.

In one possible implementation, the first determination sub-module is specifically configured to:
filter out at least one function computation unit from the at least one computation unit to be used according to the unit type of the at least one computation unit to be used, the function computation unit being of a preset unit type; and
determine the sum of the complexity representation data of all the function computation units as the self-complexity representation data of the target formula.

In one possible implementation, the interaction apparatus 400 further includes:
a data obtaining module configured to obtain size representation data of input parameters of the function computation unit;
a data determination module configured to determine a complexity prediction unit corresponding to the function computation unit according to a unit identifier of the function computation unit; and
a data prediction module configured to input the size representation data into the complexity prediction unit to obtain the complexity representation data of the function computation unit output by the complexity prediction unit.

In one possible implementation, the complexity prediction unit is derived from a fitting process according to a fitting reference data set corresponding to the function computation unit and a curve to be fitted corresponding to the function computation unit; and the fitting reference data set includes at least one first input parameter size representation data corresponding to the function computation unit and actual complexity representation data corresponding to the at least one first input parameter size representation data;
or
the complexity prediction unit is derived from a training process according to a training data set corresponding to the function computation unit and a model to be trained corresponding to the function computation unit; and the training data set includes at least one second input parameter size representation data corresponding to the function computation unit and actual complexity representation data corresponding to the at least one second input parameter size representation data.

In one possible implementation, if an upstream computation unit corresponding to the function computation unit exists in the target formula, the size representation data of the input parameters of the function computation unit is determined from the size representation data of the output result of the upstream computation unit

In one possible implementation, the size representation data of the output result of the upstream computation unit is determined according to the unit type of the upstream computation unit.

In a possible implementation, the second display module 402 is specifically configured to: in response to a formula editing operation triggered for the table content editing page, determine overall complexity representation data for a target formula corresponding to the formula editing operation, and display the overall complexity representation data for the target formula on the table content editing page, and display adjustment suggestion prompt information corresponding to the target formula.

The interaction apparatus 400 further includes:
a third display module configured to, in response to a trigger operation for the adjustment suggestion prompt information, display a formula adjustment guide interface corresponding to the target formula.

As can be seen from the above related contents of an interaction apparatus 400, for the interaction apparatus 400 provided in the embodiment of the present disclosure, when an interaction apparatus 400 is displaying a table content editing page corresponding to a target table (a certain spreadsheet), after a formula editing operation triggered for the table content editing page is received by an interaction apparatus 400, overall complexity representation data of a target formula corresponding to the formula editing operation is determined, and the overall complexity representation data of the target formula is displayed on the table content editing page, such that a user can view the overall complexity representation data of the target formula in as much real time as possible after editing the target formula. Thus, the understanding requirement of the user for the complexity of the target formula can be met, thereby facilitating improvement of the user experience.

In addition, since the overall complexity representation data of the above target formula is theoretically derived based on the complexity representation data of the minimum computation unit to which the target formula relates, it is not necessary to complete the execution process for the target formula when obtaining the overall complexity representation data of the target formula. This makes it possible to effectively avoid the adverse effects caused by the execution of the target formula (e.g., it takes a lot of time, etc.), thereby improving the efficiency of the determination of the overall complexity representation data of the target formula, which in turn improves the real-time display of the overall complexity representation data, thus better improving the user experience.

In addition, an embodiment of the present disclosure further provides an electronic device. The device includes a processor and a memory. The memory is configured to store instructions or a computer program; and the processor is configured to execute the instructions or computer program in the memory to enable the electronic device to perform any implementation of the interaction method according to the embodiments of the present disclosure.

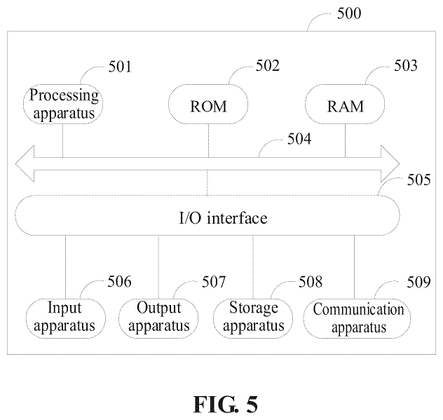

Reference is made to FIG. 5, which is a schematic diagram of a structure of an electronic device 500 suitable for implementing an embodiment of the present disclosure. A terminal device in this embodiment of the present disclosure may include, but is not limited to, mobile terminals such as a mobile phone, a notebook computer, a digital broadcast receiver, a personal digital assistant (PDA), a tablet computer (PAD), a portable media player (PMP), and a vehicle-mounted terminal (e.g., a vehicle navigation terminal), and fixed terminals such as a digital TV and a desktop computer. The electronic device shown in FIG. 5 is merely an example, and shall not impose any limitation on the function and scope of use of the embodiments of the present disclosure.

As shown in FIG. 5, the electronic device 500 may include a processing apparatus (e.g., a central processing unit and a graphics processing unit) 501 that may perform various suitable actions and processes in accordance with a program stored in a read-only memory (ROM) 502 or a program loaded from a storage apparatus 508 into a random access memory (RAM) 503. The RAM 503 further stores various programs and data required for operations of the electronic device 500. The processing apparatus 501, the ROM 502, and the RAM 503 are connected to one another through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 5 shows the electronic device 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 509, installed from the storage apparatus 508, or installed from the ROM 502. The computer program, when executed by the processing apparatus 501, performs the above functions defined in the method in the embodiments of the present disclosure.

The electronic device according to this embodiment of the present disclosure and the method according to the above embodiments belong to the same inventive concept. For the technical details not exhaustively described in this embodiment, reference may be made to the above embodiments, and this embodiment and the above embodiments have the same beneficial effects.

An embodiment of the present disclosure also provides a computer-readable medium having instructions or a computer program stored therein which, when run on a device, cause the device to perform any implementation of the interaction method provided by embodiments of the present disclosure.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client or a server may perform communication by using any currently known or future-developed network protocol such as a hypertext transfer protocol (HTTP), and may interconnect with digital data communication (e.g., a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, enable the electronic device to perform the above method.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of the unit/module does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

It should be noted that the various embodiments in this specification are described in a progressive manner, and each embodiment focuses on the differences from other embodiments. The same or similar parts between the various embodiments may be referenced to each other. For the system or apparatus disclosed in this embodiment, since it corresponds to the method disclosed in the embodiments, the description is relatively simple, and for the related parts, reference may be made to the description of the method.

It should be understood that, in the present disclosure, “at least one” means one or more, and “a plurality of” means two or more. The term “and/or” is used to describe an association relationship between associated objects, and indicates that three relationships may exist, for example, A and/or B may indicate that: only A exists, only B exists, and both A and B exist, where A or B may be singular or plural. The character “/” generally indicates an “or” relationship between the associated objects. “At least one of the following” or similar expressions refers to any combination of these items, including any combination of single items or plural items. For example, at least one of a, b, or c may indicate: a, b, and c, “a and b”, “a and c”, “b and c”, or “a and b and c”, where a, b, or c may be singular or plural.

It should also be noted that, herein, relative terms such as “first” and “second” are only used to distinguish one entity or operation from another entity or operation, and do not necessarily require or imply that such an actual relationship or order exists between these entities or operations. Moreover, the terms “include” and “comprise”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including a . . . ” does not exclude another identical element in a process, method, article, or device that includes the element.

The steps of the method or algorithm described in conjunction with the embodiments disclosed herein may be implemented directly in hardware, in a software module executed by a processor, or in a combination of the two. The software module may be disposed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

With respect to the above description of the disclosed embodiments, those skilled in the art could implement or use the present disclosure. Various modifications to these embodiments are apparent to those skilled in the art, and the general principle defined herein may be practiced in other embodiments without departing from the spirit or scope of the present disclosure. Therefore, the present disclosure will not be limited to the embodiments shown herein, but extends to the widest scope that complies with the principles and novelty disclosed in this specification.

1. An interaction method, comprising:
displaying a table content editing page corresponding to a target table;
in response to a formula editing operation triggered for the table content editing page, determining overall complexity representation data of a target formula corresponding to a formula editing operation, and displaying the overall complexity representation data of the target formula on the table content editing page, wherein the overall complexity representation data is determined based on complexity representation data of a minimum computation unit in the target formula.

2. The method according to claim 1, wherein a determination process of the overall complexity representation data of the target formula comprises:
subjecting the target formula to minimum computation unit parsing, to obtain at least one computation unit to be used;
determining self-complexity representation data of the target formula based on complexity representation data of the at least one computation unit to be used; and
determining the overall complexity representation data of the target formula based on the self-complexity representation data of the target formula.

3. The method according to claim 2, wherein the determining the overall complexity representation data of the target formula based on the self-complexity representation data of the target formula comprises:
subjecting the self-complexity representation data of the target formula and the self-complexity representation data of at least one formula to be referenced to summation processing, to obtain the overall complexity representation data of the target formula in response to there being a preset dependency relationship between the target formula and the at least one formula to be referenced in the target table; and
determining the self-complexity representation data of the target formula as the overall complexity representation data of the target formula in response to there being no preset dependency relationship between the target formula and each formula in the target table.

4. The method according to claim 2, wherein the determining self-complexity representation data of the target formula based on complexity representation data of the at least one computation unit to be used comprises:
determining the self-complexity representation data of the target formula based on the complexity representation data of the at least one computation unit to be used, and a unit type of the at least one computation unit to be used.

5. The method according to claim 4, wherein the determining the self-complexity representation data of the target formula based on the complexity representation data of the at least one computation unit to be used, and a unit type of the at least one computation unit to be used comprises:
selecting at least one function computation unit from the at least one computation unit to be used based on the unit type of the at least one computation unit to be used, wherein the function computation unit is of a preset unit type; and
determining a sum of the complexity representation data of all the function computation units as the self-complexity representation data of the target formula.

6. The method according to claim 5, wherein a determination process of the complexity representation data of the function computation unit comprises:
obtaining size representation data of input parameters of the function computation unit;
determining a complexity prediction unit corresponding to the function computation unit based on a unit identifier of the function computation unit; and
inputting the size representation data into the complexity prediction unit, to obtain the complexity representation data of the function computation unit output by the complexity prediction unit.

7. The method according to claim 6, wherein the complexity prediction unit is obtained by performing fitting based on a fitting reference data set corresponding to the function computation unit, and a curve to be fitted that corresponds to the function computation unit; and
the fitting reference data set comprises at least one piece of first input parameter size representation data corresponding to the function computation unit, and actual complexity representation data corresponding to the at least one piece of first input parameter size representation data;
or
the complexity prediction unit is obtained by performing training based on a training data set corresponding to the function computation unit, and a model to be trained that corresponds to the function computation unit; and the training data set comprises at least one piece of second input parameter size representation data corresponding to the function computation unit, and actual complexity representation data corresponding to the at least one piece of second input parameter size representation data.

8. The method according to claim 6, wherein in response to an upstream computation unit corresponding to the function computation unit existing in the target formula, the size representation data of the input parameters of the function computation unit is determined based on size representation data of an output result of the upstream computation unit.

9. The method according to claim 8, wherein the size representation data of the output result of the upstream computation unit is determined based on the unit type of the upstream computation unit.

10. The method according to claim 1, further comprising:
in response to a formula editing operation triggered for the table content editing page, displaying adjustment suggestion prompt information corresponding to the target formula; and
in response to a trigger operation for the adjustment suggestion prompt information, displaying a formula adjustment guide interface corresponding to the target formula.

11. (canceled)

12. An electronic device, comprising: a processor and a memory, wherein
the memory is configured to store instructions or a computer program; and
the processor is configured to execute the instructions or computer program stored in the memory to cause the electronic device to:
display a table content editing page corresponding to a target table;
in response to a formula editing operation triggered for the table content editing page, determine overall complexity representation data of a target formula corresponding to a formula editing operation, and display the overall complexity representation data of the target formula on the table content editing page, wherein the overall complexity representation data is determined based on complexity representation data of a minimum computation unit in the target formula.

13. A non-transitory computer-readable medium, storing instructions or a computer program which, when run on a device, causes the device to:
display a table content editing page corresponding to a target table;
in response to a formula editing operation triggered for the table content editing page, determine overall complexity representation data of a target formula corresponding to a formula editing operation, and display the overall complexity representation data of the target formula on the table content editing page, wherein the overall complexity representation data is determined based on complexity representation data of a minimum computation unit in the target formula.

14. The device according to claim 12, wherein the instructions causing the processor to determine the overall complexity representation data of the target formula comprises instructions causing the processor to:
subject the target formula to minimum computation unit parsing, to obtain at least one computation unit to be used;
determine self-complexity representation data of the target formula based on complexity representation data of the at least one computation unit to be used; and
determine the overall complexity representation data of the target formula based on the self-complexity representation data of the target formula.

15. The device according to claim 14, wherein the instructions causing the processor to determine the overall complexity representation data of the target formula based on the self-complexity representation data of the target formula comprises instructions causing the processor to:
subject the self-complexity representation data of the target formula and the self-complexity representation data of at least one formula to be referenced to summation processing, to obtain the overall complexity representation data of the target formula in response to there being a preset dependency relationship between the target formula and the at least one formula to be referenced in the target table; and
determine the self-complexity representation data of the target formula as the overall complexity representation data of the target formula in response to there being no preset dependency relationship between the target formula and each formula in the target table.

16. The device according to claim 14, wherein the instructions causing the processor to determine self-complexity representation data of the target formula based on complexity representation data of the at least one computation unit to be used comprises instructions causing the processor to:
determine the self-complexity representation data of the target formula based on the complexity representation data of the at least one computation unit to be used, and a unit type of the at least one computation unit to be used.

17. The device according to claim 16, wherein the instructions causing the processor to determine the self-complexity representation data of the target formula based on the complexity representation data of the at least one computation unit to be used, and a unit type of the at least one computation unit to be used comprises instructions causing the processor to:
select at least one function computation unit from the at least one computation unit to be used based on the unit type of the at least one computation unit to be used, wherein the function computation unit is of a preset unit type; and
determine a sum of the complexity representation data of all the function computation units as the self-complexity representation data of the target formula.

18. The device according to claim 17, wherein the instructions causing the processor to determine the complexity representation data of the function computation unit comprises instructions causing the processor to:
obtain size representation data of input parameters of the function computation unit;
determine a complexity prediction unit corresponding to the function computation unit based on a unit identifier of the function computation unit; and
input the size representation data into the complexity prediction unit, to obtain the complexity representation data of the function computation unit output by the complexity prediction unit.

19. The device according to claim 18, wherein the complexity prediction unit is obtained by performing fitting based on a fitting reference data set corresponding to the function computation unit, and a curve to be fitted that corresponds to the function computation unit; and
the fitting reference data set comprises at least one piece of first input parameter size representation data corresponding to the function computation unit, and actual complexity representation data corresponding to the at least one piece of first input parameter size representation data;
or
the complexity prediction unit is obtained by performing training based on a training data set corresponding to the function computation unit, and a model to be trained that corresponds to the function computation unit; and the training data set comprises at least one piece of second input parameter size representation data corresponding to the function computation unit, and actual complexity representation data corresponding to the at least one piece of second input parameter size representation data.

20. The device according to claim 19, wherein in response to an upstream computation unit corresponding to the function computation unit existing in the target formula, the size representation data of the input parameters of the function computation unit is determined based on size representation data of an output result of the upstream computation unit.

21. The device according to claim 18, wherein the size representation data of the output result of the upstream computation unit is determined based on the unit type of the upstream computation unit.
